(19) United States
(12) Patent Application Publication
(10) Pub. No.: US 2015/0234759 A1
(43) Pub. Date: Aug. 20, 2015

(54) METHOD AND APPARATUS USING HIGH-EFFICIENCY ATOMIC OPERATIONS

(71) Applicant: QUALCOMM INCORPORATED, San Deigo, CA (US)

(72) Inventors: Zhixin Tian, Shanghai (CN); Yunfeng He, Shanghai (CN)

(21) Appl. No.: 14/425,550

(22) PCT Filed: Oct. 4, 2012
(86) PCT No.: PCT/CN2012/082523

§ 371 Date: Mar. 3, 2015

(51) Int. Cl. G06F 13/364; G06F 13/22; G06F 13/16

(52) U.S. Cl. CPC G06F 13/364; G06F 13/1673; G06F 13/1652; G06F 13/22; G06F 2213/36; G06F 2213/1602

(57) ABSTRACT

A method of controlling access between multiple master devices to a shared resource is disclosed. The method includes receiving a request to access the shared resource from a first master device, and determining availability of the shared resource. If the shared resource is available, a successful response is returned to the first master device to establish access by the first master device to the shared resource. If the shared resource is unavailable, a failed response is returned to the first master device. During the resource's unavailability, it is automatically monitored for when the shared resource becomes available. Once available, the first master device is automatically notified.

### TECHNICAL FIELD

The present embodiments relate generally to data communications, and more particularly to methods and apparatus that provide flow control for buffering data.

### BACKGROUND OF RELATED ART

Atomic operations are often employed in multi-core processor architectures. Generally, an atomic operation is a set of operations that are combined so that they appear to the rest of the system as a single operation with only two possible outcomes: success or failure.

Two conventional methods of employing atomic operations include respective “lock” and “exclusive” schemes. The lock operation generally allows only one master to access a bus at a time. For multi-core applications that employ shared variables, the lock scheme may be inefficient since other masters need to wait until the active master is finished with the bus.

The exclusive scheme allows multiple masters to share the bus during operations. This is especially useful for semaphore variables that may be shared by multiple processing threads. Conventionally, the exclusive operation involves a first master performing a read access to a memory. A write access to the same location is then made by the same master. If the location address didn't change since the read access, the write access succeeds. A second master may initiate a read during the interval between the first masters' read and write cycle. In the event that a fail occurs, the second master polls the shared resource by sending requests until the resource is available. Once available, the request for exclusive access to the resource is repeated.

While the exclusive scheme works well for its intended applications, repetitive polling to determine resource availability increases bus traffic and context switching, correspondingly reducing available signaling bandwidth along the bus and increasing system latency.

### SUMMARY

A method of controlling access between multiple master devices to a shared resource is disclosed. The method includes receiving a request to access the shared resource from a first master device, and determining availability of the shared resource. If the shared resource is available, a successful response is returned to the first master device to establish access by the first master device to the shared resource. If the shared resource is unavailable, a failed response is returned to the first master device. During the resource's unavailability, the shared resource is automatically monitored for when the shared resource becomes available. Once the shared resource becomes available, the first master device is automatically notified.

### BRIEF DESCRIPTION OF THE DRAWINGS

The present embodiments are illustrated by way of example and are not intended to be limited by the figures of the accompanying drawings, where:

FIG. 1 illustrates one embodiment of a multi-processor system;

FIG. 2 shows a high-level command and operation flow that implements an atomic operation using the system of FIG. 1;

FIG. 3 illustrates a flow chart that includes detailed steps corresponding to one embodiment of the command and operation flow of FIG. 2 from the perspective of a master device;

FIG. 4A illustrates a portion of a flow chart that includes detailed steps corresponding to one embodiment of a method corresponding to the command and operation flow of FIG. 2 from the perspective of a slave device; and

FIG. 4B illustrates a portion of a flow chart similar to FIG. 4A.

### DETAILED DESCRIPTION

In accordance with the present embodiments, a method of controlling access between multiple master devices to a shared resource is disclosed. The method includes receiving a request to access the shared resource from a first master device, and determining availability of the shared resource. If the shared resource is available, a successful response is returned to the first master device to establish exclusive access by the first master device to the shared resource. If the shared resource is unavailable, a failed response is returned to the first master device. During the resource's unavailability, the shared resource is automatically monitored for when the shared resource is available. Once available, the first master device is automatically notified. By providing automatic monitoring and notification, polling and related context switching from master devices may be significantly reduced, improving system performance.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

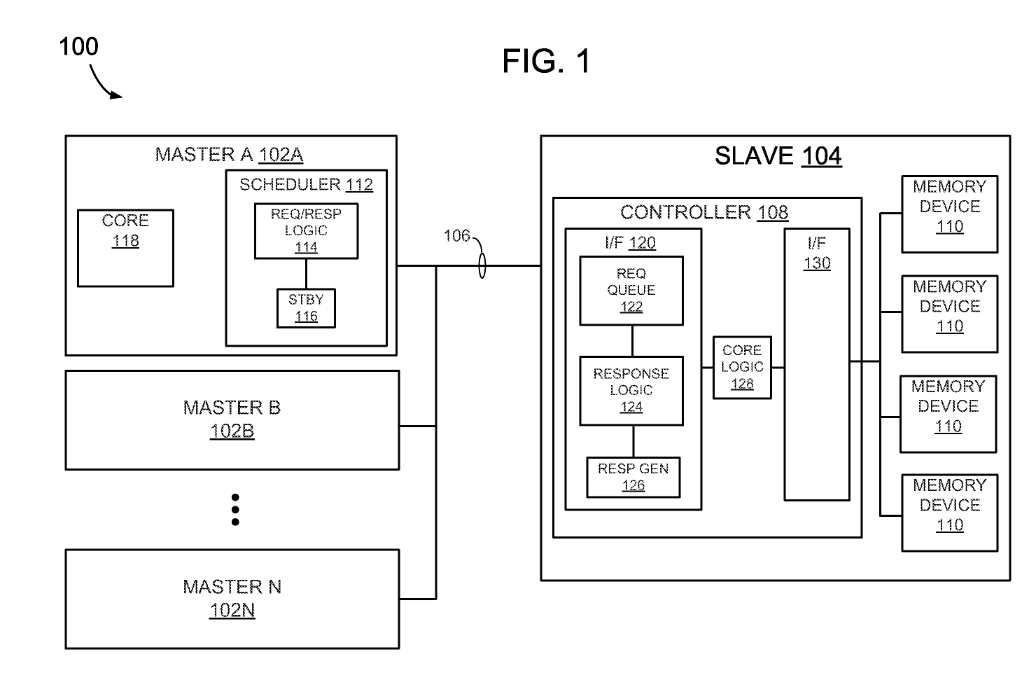

More specifically, and referring generally to FIG. 1, a multi-master signaling system 100 employs plural master devices 102A-102N that interconnect to a slave device 104 via a shared bus 106. In one embodiment, the master devices 102A-102N are embodied as integrated circuit processors that may be disposed on one or more integrated circuit chips. The slave device 104, in one embodiment, is embodied as a memory system that employs a memory controller 108 to arbitrate access to one or more memory devices 110. To allow for shared access to the memory while maintaining high utilization and efficiency, new schemes for semaphoretype and non-semaphore type atomic operations are supported, more fully described below.

Further referring to FIG. 1, each master device, such as device 102A, includes a scheduler 112 that employs request/response logic 114 and a standby queue 116. The request/response logic 114 generates and receives messages in the form of commands or requests/responses that are dispatched between the master device 102A and the slave device 104 to coordinate exclusive access for carrying out an operation. Core circuitry 118 in the master device 102A provides the computational resources for generating and or processing data that is written to or retrieved from the slave device 104 as a result of the exclusive access. The standby queue 116 temporarily stores commands and data for a given atomic transaction until exclusive access between the master and the slave can be secured.

With continued reference to FIG. 1, the slave device 104 includes a scheduling interface 120 that communicates with the multiple master devices 102A-102N to coordinate exclusive transactions at varying times. The scheduling interface 120 includes a request queue 122 such as a buffer for receiving and storing requests from the various master devices such as on a first-in-first-out basis. Response logic 124 couples to the request queue 122 to detect the availability of the slave device 104 for exclusive access. In one embodiment, the response logic 124 includes a counter that exhibits a first value (such as a 1) when the memory is available for access, and a second decremented value (such as a 0) when the memory system 104 is locked in an operation with one of the master devices. The controller 108 also includes a response generator 126 to generate and send messages to the various master devices as more fully described below.

Further referring to FIG. 1, the scheduling interface 120 couples to core logic 128 that provides processing resources for tracking and handling the various operations that are in-process and/or queued for processing by the controller 108. As noted above, in one embodiment, the shared resource that is alternatingly exclusively accessed by each of the master devices is a memory. Consequently, a memory interface 130 is provided to carry out accesses between the controller 108 and the one or more memory devices 110. In some embodiments, the controller 108 and memory devices 110 are embodied as separate integrated circuit devices. In other embodiments, the controller functionality may be distributed and included as a circuit in each of the master devices 102A-102N.

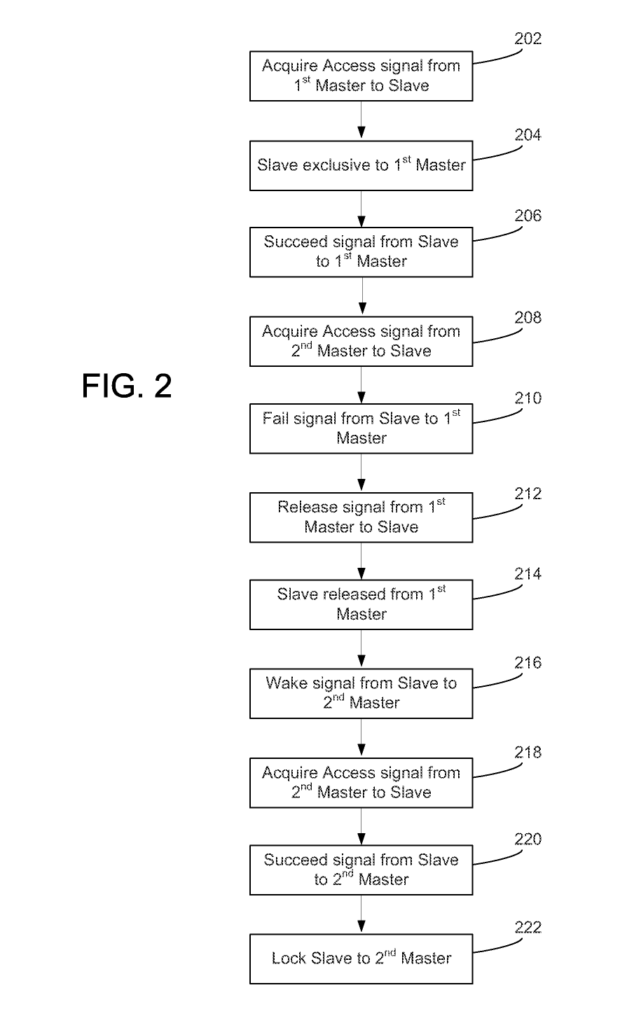

FIG. 2 illustrates a flowchart showing a sequence of operations between multiple master devices and a shared slave device. Exclusive access to the shared resource is arbitrated through use of a semaphoretype atomic operation that involves a sequence of commands to carry out a single transaction. The atomic operations reduce polling from master devices not having exclusive access to the shared resource. As a result, the reduced polling and associated context switching improves the signaling bandwidth of the interconnect, thereby improving system performance.

Further referring to FIG. 2, and using a memory system context as one example, a first master device (such as a processor) desiring exclusive access to the shared slave device (such as memory) issues a first request “ACQUIRE ACCESS” to the slave device, at 202. If the slave device is available for an exclusive operation with another master device, at 204, a “SUCCEED” signal is issued from the slave device, at 206, to the first master device. This establishes a locked condition between the two devices for carrying out a series of read and/or write data transactions between the first master device and the slave device.

With continued reference to FIG. 2, should a second master device issue an exclusive access request to the slave device, at 208, while the first master has exclusive access, the locked condition with the first master device causes the slave to respond to the second master device with a “FAIL” response, at 210. The second master device then enters a standby mode of operation to perform the operation until the memory is available. Availability occurs when the first master device issues a “RELEASE” command, at 212. In response to the RELEASE command, the slave device is released from the first master device, at 214, and automatically generates and issues a “WAKE” command to the second master device (assuming the prior failed request is the highest priority operation in the slave device queue), at 216. Once the second master receives the WAKE command, a new ACQUIRE request is issued to establish a locked state with the slave device, at 218, with a corresponding SUCCEED command issued by the slave to confirm exclusivity, at 220. At this point, the slave device is locked to the second master device, at 222.

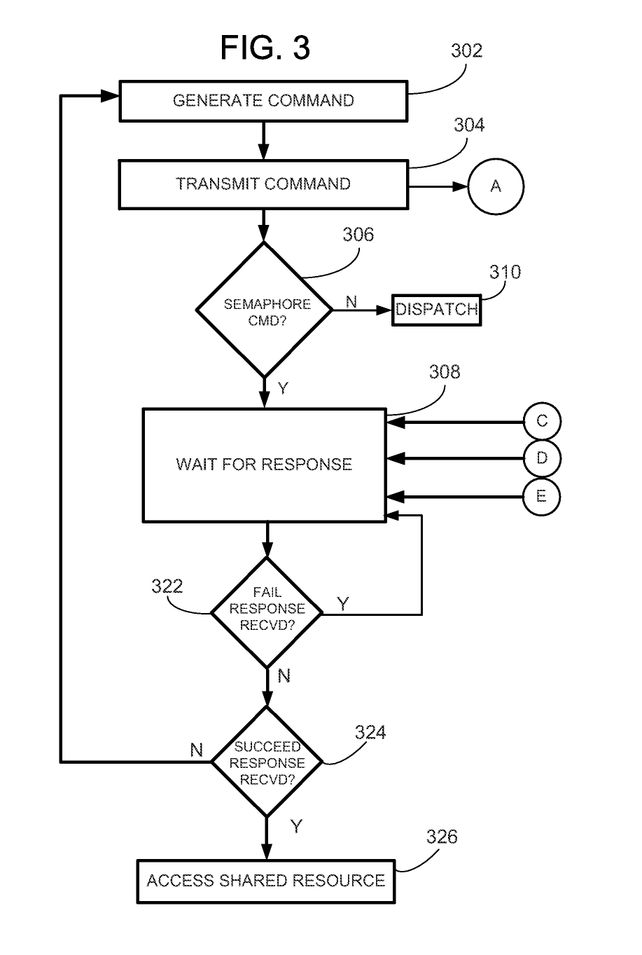

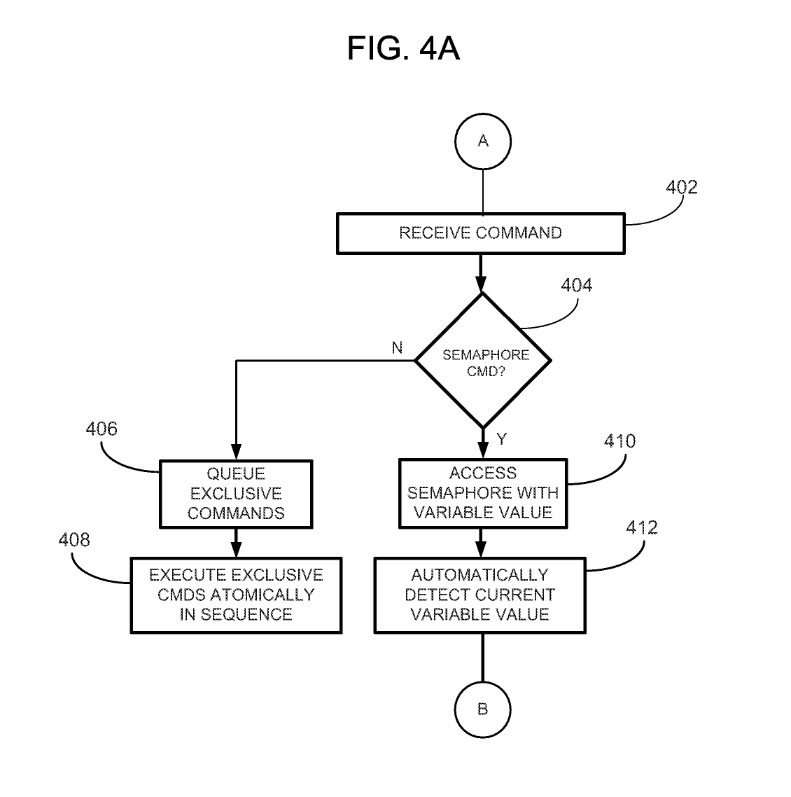

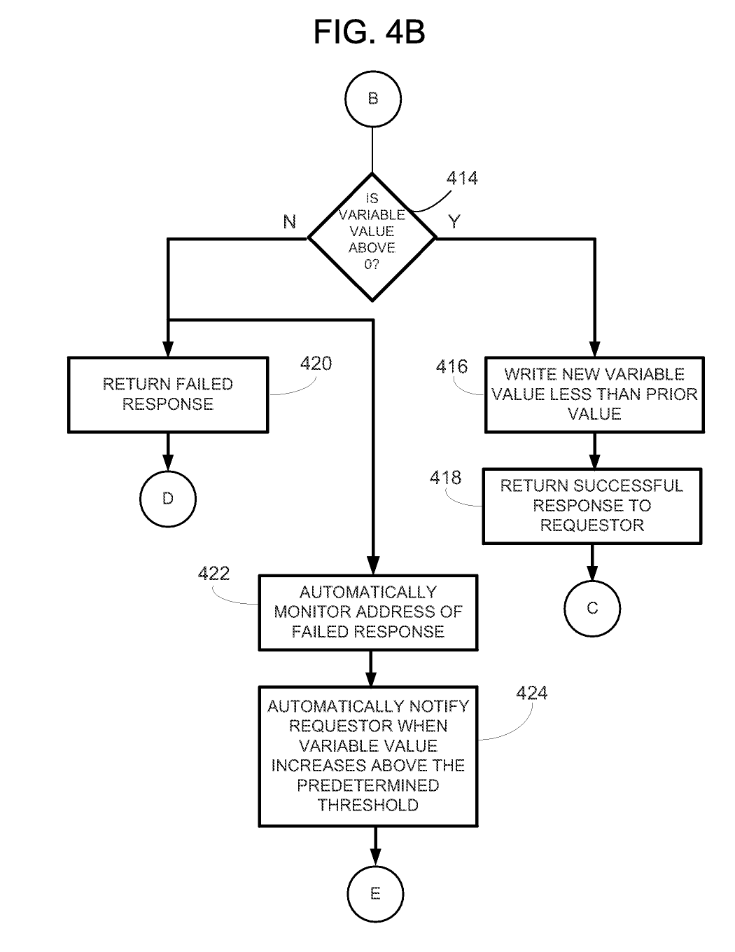

FIG. 3 illustrates one embodiment of method steps in further detail from the perspective of a master device that correspond to the method described above in FIG. 2 relating to semaphoretype atomic operations. When the master device needs to read data from (or write data to) the memory controlled by the slave device, it executes instructions to have the request/response logic 114 generate an “ACQUIRE” access command, at 302, and transmit the request to the slave device, at 304. The request transmission is represented by bubble “A”, which transfers to FIG. 4A. If the command is a semaphoretype operation, determined at 306, then the master device waits for a response before taking further actions with the slave, at 308. If the command is a non-semaphore type of command, all other operations and operands are packetized with the command, and it is dispatched to the slave, at 310.

Referring now to FIG. 4A, the slave device scheduling interface 120 receives the “ACQUIRE” command from the first master IC, at step 402 (via bubble A). A determination is then made, at 404, whether the request involves a semaphoretype operation. If not, then the slave queues the exclusive commands in the request queue 122, at 406, and executes the exclusive commands atomically in sequence, at 408. If the operation is a semaphoretype operation, then a variable value indicating the memory's availability is accessed, at 410, and the current value of the variable is detected, at 412.

With reference to FIG. 4B, the detected value of the variable is evaluated by the response logic 124 (via bubble “B” joining FIGS. 4A and 4B), at 414. In one embodiment, a value greater than “0” indicates availability of the resource, which results in writing a new variable value decremented from the previous value, at 416. A successful response is then returned to the first master IC, at 418, via bubble “C”.

In the event that the variable value is not above the threshold, thus indicating that the resource is unavailable, a failed response is generated by the response generator 126 and returned to the requesting master, at 420, via bubble “D”. The resource is automatically monitored by the response logic 124, at 422, and an automatic notification (response) sent to the requesting master, via bubble “E”, when the variable value goes above the threshold, at 424.

Non-semaphore type atomic operations involve packetizing all of the operation information into one access. No automatic detection or notification mechanisms are applied.

Referring back to FIG. 3, for semaphoretype operations, the master device waits in a standby mode of operation where it evaluates received messages and determines whether a “FAIL” response was received, at 322, via bubbles C, D, or E. The standby mode is activated by the standby queue 116 (FIG. 1), which temporarily stores the original access request in a buffer until the master can gain access to the slave. When a non-FAIL response is returned (either a SUCCEED or a WAKE), and received by the request/response logic 114 (FIG. 1), a further determination is carried out, at 324, whether the received message was a SUCCEED. If so, the link between the master device and the slave device is locked, and a sequence of read and/or write operations occurs to carry out the atomic transaction, at 326. If a SUCCEED response was not received, then a “WAKE” response is assumed, and the master device generates a subsequent “ACQUIRE” command at 302 for dispatch to the slave device to initiate a lock condition, which is confirmed through receipt of a subsequent “SUCCEED” response via the steps described above.

The proposed schemes thus provide atomic operations that minimize the number of accesses and reduce polling operations to determine availability. This correspondingly decreases the overhead involved with accessing the bus and associated context switching activities.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of controlling access between multiple master devices to a shared resource, the method comprising:
receiving a request to access the shared resource from a first master device;
determining availability of the shared resource;
if the shared resource is available, returning a successful response to the first master device to establish access by the first master device to the shared resource; and
if the shared resource is unavailable:
returning a failed response to the first master device;
automatically monitoring for when the shared resource becomes available; and
automatically notifying the first master device when the shared resource becomes available.

2. The method of claim 1, wherein determining availability comprises:
identifying a variable having a value that represents whether the shared resource is available for access; and
detecting a current value for the variable.

3. The method of claim 2, wherein automatically monitoring comprises:
detecting when the variable value reaches a predetermined threshold value.

4. The method of claim 2, wherein the variable comprises a semaphore variable.

5. The method of claim 1 and further comprising:
receiving a request for access to the shared resource from each of a plurality of master devices; and
queuing the requests.

6. The method of claim 5, wherein automatically notifying is based on an ordering of the queuing of the requests.

7. A device comprising:
request logic to generate a command requesting exclusive access to a shared resource for carrying out an operation, the shared resource shared by multiple devices; and
standby logic responsive to a fail response signal from the shared resource to:
enter a standby mode with respect to the operation, and
maintain the standby mode until receipt of a wake response from the shared resource.

8. The device of claim 6 embodied as an integrated circuit processor.

9. The device of claim 7, and further comprising:
an interface for coupling to a signaling bus, the signaling bus also coupled to the multiple devices and the shared resource.

10. The device of claim 7, wherein the standby logic is responsive to receipt of the wake response by re-requesting exclusive access to the shared resource.

11. A device comprising:
an interface for arbitrating a transaction between a shared resource and a master device;
a monitor to receive an incoming request for access to the shared resource from the master device;
arbitration logic for determining availability of the shared resource; and
response logic to generate signals indicating success or failure of a given master device to gain access to the shared resource;
wherein the interface automatically generates a wake signal for a second master device from the multiple master devices, the second master device identified in the request queue based on the determined availability of the shared resource.

12. The device of claim 11, wherein the monitor receives incoming requests for access to the shared resource from multiple master devices.

13. The device of claim 12, wherein the monitor comprises a request queue.

14. The device of claim 13, and further comprising logic to order the incoming requests in the request queue.

15. The device of claim 11 embodied as a memory system.

16. The device of claim 11 wherein the shared resource comprises a memory.

17. The device of claim 11 wherein the arbitration logic comprises a counter circuit that generates a value indicating whether the shared resource is available for access.

18. A system comprising:
a plurality of master devices;
a bus coupled to the plurality of master devices; and
a slave device coupled to the bus and including a resource shared by the plurality of master devices, the slave device including:
an interface for arbitrating an exclusive transaction between the shared resource and a first master device from the plurality of master devices;
a request queue to monitor incoming requests for access to the shared resource from at least a portion of the plurality of master devices;
arbitration logic for determining availability of the shared resource;
response logic to generate signals indicating success or failure of a given master device from the plurality of master devices to gain access to the shared resource, wherein the given master device sends to the slave device a request to access the shared resource; and
wherein the interface automatically generates a wake signal for a second master device identified in the request queue based on the determined availability of the shared resource.

19. The system of claim 18 wherein the plurality of master devices comprise multiple processors.

20. The system of claim 18 wherein the slave device comprises a memory system.

21. The system of claim 18 wherein the shared resource comprises a memory.
